(19) United States
(12) Patent Application Publication
(10) Pub. No.: US 2025/0131535 A1
(43) Pub. Date: Apr. 24, 2025

(54) IMAGE RESTORATION METHOD AND APPARATUS, DEVICE, MEDIUM AND PRODUCT

(71) Applicant: Beijing Youzhuju Network Technology Co., Ltd., Beijing (CN)

(72) Inventors: Xiaofei MAO, Beijing (CN); Can HUANG, Beijing (CN)

(21) Appl. No.: 18/834,506

(22) PCT Filed: Feb. 23, 2023
(86) PCT No.: PCT/CN2023/077871

§ 371 Date: Jul. 30, 2024

(30) Foreign Application Priority Data
Mar. 21, 2022 (CN) 202210278165.X

(51) Int. Cl. G06T 5/60; G06T 3/40; G06V 10/54; G06V 10/56; G06V 10/77

(52) U.S. Cl. CPC G06T 5/60; G06T 3/40; G06V 10/54; G06V 10/56; G06V 10/7715; G06T 2207/20016; G06T 2207/20081

(57) ABSTRACT

The present disclosure provides an image restoration method and apparatus, a device, a medium and a product. The method includes: acquiring an image to be restored; and then, inputting the image to be restored into a structure restoration model, obtaining a first feature sequence and a second feature sequence by down-sampling the image to be restored based on a plurality of branches of the structure restoration model, converting the first feature sequence into a third feature sequence that has the same length as the second feature sequence, fusing the third feature sequence with the second feature sequence, and obtaining an image in which the structure of the image to be restored is restored by performing structure restoration on the image to be restored according to a fused feature sequence. In this way, a restored image with higher restoration precision and a better effect can be obtained.

### CROSS-REFERENCE TO RELATED APPLICATION(S)

This application claims priority to Chinese Application No. 202210278165.X, filed on Mar. 21, 2022, and entitled “Image Restoration Method and Apparatus, Device, Medium and Product”, the disclosure of which is incorporated herein by reference in its entity.

### FIELD

The present disclosure relates to the technical field of computers, and in particular to an image restoration method and apparatus, a device, a computer-readable storage medium and a computer program product.

### BACKGROUND

With the continuous maturity of an image processing technology, a user has proposed higher requirements for a restoration effect of image restoration by using the image processing technology. The image restoration refers to restoring unknown information in an image based on known information in the image, so as to restore a missing part in the image.

Generally, the image restoration technology is to determine a reference area and an area to be restored in an image to be restored, and to determine, via a neural network model, a pixel value of the area to be restored according to a pixel value of the reference area for image restoration. However, this image restoration technology may lead to distortion situations such as ripples and distortion in a restored area, which does not meet the requirements of the user for the image restoration effect. How to improve the effect of image restoration becomes an urgent problem to be solved.

### SUMMARY

The objective of the present disclosure is to provide an image restoration method and apparatus, a device, a computer-readable storage medium and a computer program product, which can restore an image from an overall perspective of the image to obtain a more real restoration effect.

In a first aspect, the present disclosure provides an image restoration method, including: acquiring an image to be restored; and inputting the image to be restored into a structure restoration model, obtaining a first feature sequence and a second feature sequence by down-sampling the image to be restored based on a plurality of branches of the structure restoration model, converting the first feature sequence into a third feature sequence that has the same length as the second feature sequence, fusing the third feature sequence with the second feature sequence, and obtaining a first restored image by performing, according to a fused feature sequence, structure restoration on the image to be restored, wherein the first restored image is an image in which a structure of the image to be restored is restored.

In a second aspect, the present disclosure provides an image restoration apparatus, including: an acquisition module, configured to acquire an image to be restored; and a structure restoration module, configured to input the image to be restored into a structure restoration model, obtain a first feature sequence and a second feature sequence by down-sampling the image to be restored based on a plurality of branches of the structure restoration model, convert the first feature sequence into a third feature sequence that has the same length as the second feature sequence, fuse the third feature sequence with the second feature sequence, and obtain a first restored image by performing, according to a fused feature sequence, structure restoration on the image to be restored, wherein the first restored image is an image in which the structure of the image to be restored is restored.

In a third aspect, the present disclosure provides an electronic device, including: a storage apparatus, storing a computer program thereon; and a processing apparatus, configured to execute the computer program in the storage apparatus to implement the steps of the method in the first aspect of the present disclosure.

In a fourth aspect, the present disclosure provides a computer-readable medium, storing a computer program thereon, wherein the program implements, when executed by a processing apparatus, the steps of the method in the first aspect of the present disclosure.

In a fifth aspect, the present disclosure provides a computer program product, including an instruction, wherein the computer program product causes, when running on a device, the device to execute the steps of the method in the first aspect.

It can be seen from the above technical solutions that the present disclosure has at least the following advantages:

In the above technical solutions, an electronic device acquires an image to be restored, then inputs the image to be restored into a structure restoration model, obtains a first feature sequence and a second feature sequence by down-sampling the image to be restored based on a plurality of branches of the structure restoration model, converts the first feature sequence into a third feature sequence that has the same length as the second feature sequence, fuses the third feature sequence with the second feature sequence, and obtains an image in which the structure of the image to be restored is restored by performing structure restoration on the image to be restored according to a fused feature sequence. The plurality of branches in the structure restoration model can down-sample the image to be restored in different scales, then extract features of the image to be restored under different scales, and restore the image to be restored according to a fused result, so that a restored image with higher restoration precision and a better effect can be obtained.

Other features and advantages of the present disclosure will be described in detail in the following Detailed Description of Embodiments.

### BRIEF DESCRIPTION OF THE DRAWINGS

In order to more clearly illustrate the technical methods of the embodiments of the present disclosure, the drawings required in the embodiments will be briefly described below.

FIG. 1 is a schematic flowchart of an image restoration method provided in an embodiment of the present disclosure;

FIG. 2 is a schematic diagram of a structure restoration model provided in an embodiment of the present disclosure;

FIG. 3 is a schematic diagram of another structure restoration model provided in an embodiment of the present disclosure;

FIG. 4 is a schematic flowchart of another image restoration method provided in an embodiment of the present disclosure;

FIG. 5 is a schematic diagram of a texture/color restoration model provided in an embodiment of the present disclosure;

FIG. 6 is a schematic structural diagram of an image restoration apparatus provided in an embodiment of the present disclosure; and

FIG. 7 is a schematic structural diagram of an electronic device provided in an embodiment of the present disclosure.

### DETAILED DESCRIPTION OF EMBODIMENTS

The terms “first” and “second” in the embodiments of the present disclosure are used for descriptive purposes only and cannot be understood as indicating or implying relative importance or implicitly indicating the number of indicated technical features. Thus, the features defined with “first” and “second” may explicitly or implicitly include one or more of the features.

First, some technical terms involved in the embodiments of the present disclosure are introduced.

An image processing technology is generally to process a digital image, and specifically refers to a technology for analyzing and processing the digital image by a computer. Based on the image processing technology, various types of processing may be performed on the image, for example, an image having a missing part is restored, that is, an image restoration technology.

With the continuous maturity of the image processing technology, a user has proposed higher requirements for the effect of the image restoration technology. For an image to be restored, the image restoration technology is to determine a restored area and a reference area in the image to be restored, and the restored area may be an area in which a part of a pattern is missing, or may be an area whose definition does not meet the requirements of the user.

Generally, the image restoration technology may directly predict a pixel value of the restored area via a neural network model according to a pixel value of the reference area in the image to be restored, so as to restore the restored area of the image to be restored.

However, the restoration method of directly predicting the pixel value of the restored area via the neural network model only restores the image from the perspective of the pixel value, which may lead to distortion situations of the restored area, such as ripples and distortion, thus failing to meet the requirements of the user for an authenticity effect of the image restoration.

In view of this, the present disclosure provides an image restoration method, which is applied to an electronic device. The electronic device refers to a device having a data processing capability, for example, may be a server or a terminal. The terminal includes, but is not limited to, a smart phone, a tablet computer, a notebook computer, a personal digital assistant (PDA), or a smart wearable device, etc. The server may be a cloud server, for example, a central server in a central cloud computing cluster, or an edge server in an edge cloud computing cluster. Of course, the server may also be a server in a local data center. The local data center refers to a data center directly controlled by a user.

Specifically, the electronic device acquires an image to be restored, then inputs the image to be restored into a structure restoration model, obtains a first feature sequence and a second feature sequence by down-sampling the image to be restored based on a plurality of branches of the structure restoration model, converts the first feature sequence into a third feature sequence that has the same length as the second feature sequence, fuses the third feature sequence with the second feature sequence, and performs structure restoration on the image to be restored according to a fused feature sequence, so as to obtain a first restored image in which the structure of the image to be restored is restored.

In this way, the structure restoration model may restore the image to be restored according to image features of different scales, fuse the features of different scales to perform structure restoration on the image to be restored, thereby implementing the restoration of the image to be restored in terms of structure, improving the authenticity of image restoration, and meeting the requirements of the user for image restoration.

Further, the electronic device may also input the structurally restored model into a texture restoration model and/or a color restoration model for texture restoration and/or color restoration, thereby implementing the restoration of the image to be restored in terms of texture and/or color, and acquiring a restored image that better meets the requirements of the user.

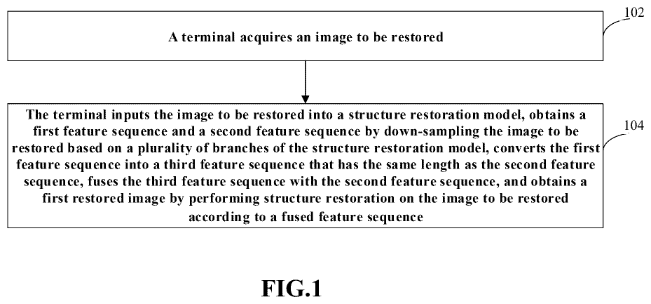

In order to make the technical solutions of the present disclosure clearer and understandable, the image restoration method provided in the embodiments of the present disclosure will be described below by taking it as an example that the electronic device is a terminal, as shown in FIG. 1, and the method includes the following steps:

S102: the terminal acquires an image to be restored.

The image to be restored may be an image having a missing part, and may also be an image whose definition does not meet the requirements of the user. The terminal may acquire the image to be restored in a plurality of manners. For example, the terminal may determine an image stored in the terminal as the image to be restored in response to a determination request of the user, and then call a storage unit in the terminal to acquire the image to be restored. The terminal may also determine an image stored in another device as the image to be restored in response to the determination request of the user, and then acquire the image to be restored from the device. The terminal may also acquire the image to be restored by calling another component, for example, the terminal may photograph a paper photo by using a camera to obtain an image to be restored in a digital format.

S104: the terminal inputs the image to be restored into a structure restoration model, obtains a first feature sequence and a second feature sequence by down-sampling the image to be restored based on a plurality of branches of the structure restoration model, converts the first feature sequence into a third feature sequence that has the same length as the second feature sequence, fuses the third feature sequence with the second feature sequence, and obtains a first restored image by performing, according to a fused feature sequence, structure restoration on the image to be restored.

The first restored image is an image in which the structure of the image to be restored is restored. Converting the first feature sequence into the third feature sequence that has the same length as the second feature sequence may include: obtaining the third feature sequence by up-sampling the first feature sequence. Converting the first feature sequence into the third feature sequence that has the same length as the second feature sequence may also include: obtaining the third feature sequence by adding the first feature sequence with a fifth feature sequence, and performing up-sampling, the fifth feature sequence has the same length as the first feature sequence, the fifth feature sequence may be obtained after a fourth feature sequence is up-sampled, and the fourth feature sequence may be obtained after the image to be restored is down-sampled by another branch of the structure restoration model. Fusing the third feature sequence with the second feature sequence may include: adding the third feature sequence with the second feature sequence, and performing encoding and decoding.

In some possible implementations, the length of the first feature sequence is four times the length of the fourth feature sequence, the length of the fifth feature sequence is the same as the length of the first feature sequence, the length of the second feature sequence is four times the length of the first feature sequence, and the length of the third feature sequence is the same as the length of the second feature sequence.

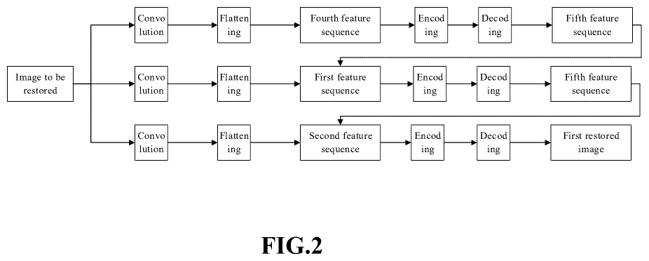

Exemplarily, as shown in FIG. 2, the terminal inputs the image to be restored to the structure restoration model, and the plurality of branches of the structure restoration model separately down-sample the image to be restored by convolution to obtain corresponding feature images, and then perform down-sampling to obtain smaller feature maps. Then, the terminal flattens the feature maps to obtain the first feature sequence, the second feature sequence and the fourth feature sequence, which have different lengths.

The structure restoration model encodes and decodes the fourth feature sequence, and converts the fourth feature sequence into the fifth feature sequence that has the same length as the first feature sequence. Then, the structure restoration model adds the fifth feature sequence with the first feature sequence, performs encoding and decoding, and then up-samples a decoding result to obtain the third feature sequence. The structure restoration model adds the third feature sequence with the second feature sequence, and performs encoding and decoding to obtain the fused feature sequence. In this way, structure restoration may be performed on the image to be restored according to the fused feature sequence, so as to obtain the first restored image.

In some possible implementations, the electronic device may also obtain the fourth feature sequence by down-sampling the image to be restored based on the plurality of branches of the structure restoration model, and the lengths of the fourth feature sequence, the first feature sequence and the second feature sequence are different from each other.

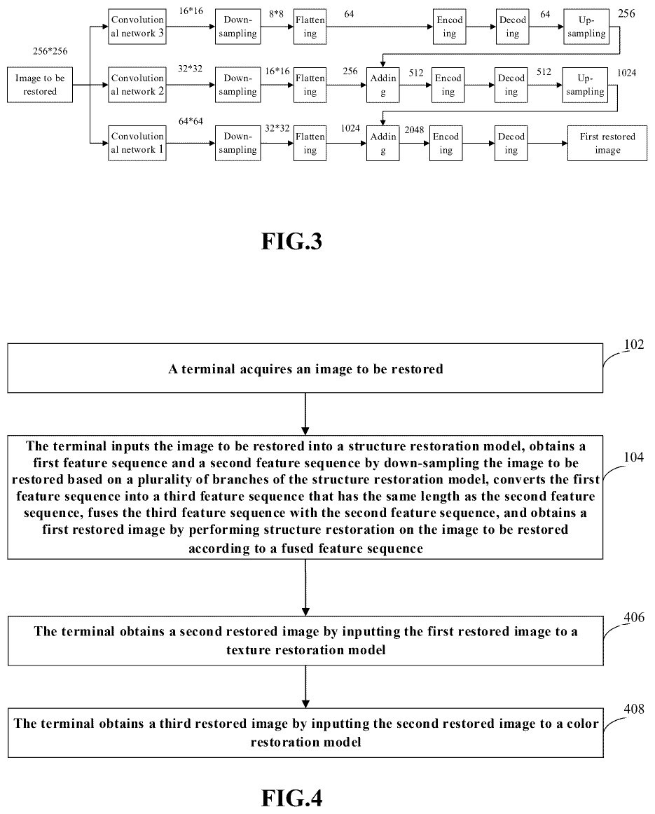

As shown in FIG. 3, in the structure restoration model, the image to be restored is down-sampled by three convolutional networks of different scales to obtain three feature maps of different scales. For example, the size of the image to be restored is 256*256, 4-fold down-sampling is performed by a convolutional network 1 (convolution1, conv1) to obtain a feature map with a size of 64*64; 8-fold down-sampling is performed by a convolutional network 2 (conv2) to obtain a feature map with a size of 32*32; and 16-fold down-sampling is performed by a convolutional network 3 (conv3) to obtain a feature map with a size of 16*16.

Then, the structure restoration model down-samples the feature maps to reduce the sizes of the feature maps to ½ of original sizes, so as to obtain feature maps with sizes of 32*32, 16*16 and 8*8. The structure restoration model then separately flattens the feature maps and converts two-dimensional feature maps into one-dimensional feature sequences, and the lengths of the sequences are respectively 1024, 256 and 64. After a sequence with a length of 64 is encoded by N encoders and decoded by N decoders, an obtained result sequence is up-sampled to obtain a sequence with a length of 256; the sequence with the length of 256 obtained by up-sampling is added with the sequence with the length of 256 obtained by flattening, an addition result is encoded and decoded, and an obtained result sequence is up-sampled to obtain a sequence with a length of 1024; and the sequence with the length of 1024 obtained by up-sampling is added with the sequence with the length of 1024 obtained by flattening, and an addition result is encoded and decoded to obtain a result feature sequence. Then, the structure of the image to be restored is restored according to the result feature sequence, so as to obtain the first restored image.

Since the structure restoration model has a plurality of branches, the plurality of branches may acquire structural features of the image to be restored from different scales, so that the image to be restored is restored based on the features of different scales, therefore the structure restoration of the image to be restored is more accurate, the accuracy of the structure restoration of the image is improved, and the usage experience of the user is improved. In addition, the structure restoration model may learn spatial layout information in the image, and consider characteristics of uniform distribution of objects in the image, so as to restore the approximate contour of the image.

The structure restoration model may be trained and obtained by a training image. Exemplarily, the terminal may mask the training image to obtain a mask image, and the size of the training image may be 256*256. Then, the terminal separately obtains training feature maps of different scales based on three branches of the structure restoration model, for example, performs 4-fold down-sampling by the conv1 to obtain a training feature map with a size of 64*64, performs 8-fold down-sampling by the conv2 to obtain a training feature map with a size of 32*32, and performs 16-fold down-sampling by the conv3 to obtain a training feature map with a size of 16*16.

Then, the structure restoration model down-samples the training feature maps to reduce the lengths of the training feature maps to ½ of the original sizes, so as to obtain training feature maps with sizes of 32*32, 16*16 and 8*8. The structure restoration model then separately flattens the training feature maps and converts two-dimensional training feature maps into one-dimensional training feature sequences, and the lengths of the sequences are respectively 1024, 256 and 64. After a sequence with a length of 64 is encoded by N encoders and decoded by N decoders, the mask image is restored by an obtained training result sequence to obtain a first restored sub-image, and then calculates the first restored sub-image and an unmasked training image to obtain a first mean square function (mean-squared loss, mse loss).

Meanwhile, the structure restoration model up-samples the training result sequence to obtain a sequence with a length of 256, adds the sequence with the length of 256 obtained by up-sampling with the sequence with the length of 256 obtained by flattening, performs encoding and decoding on an added result, then restores the mask image by using an obtained training result sequence to obtain a second restored sub-image, and then calculates the second restored sub-image and an unmasked training image to obtain a second mean square function.

Moreover, the structure restoration model further up-samples the obtained training result sequence to obtain a sequence with a length of 1024, adds the sequence with the length of 1024 obtained by up-sampling with the sequence with the length of 1024 obtained by flattening, and encodes and decodes an added result to obtain a result feature sequence. Then, the structure restoration model restores the structure of the image to be restored according to the result feature sequence to obtain a first restored image, and calculates the first restored image and the unmasked training image to obtain a third mean square function.

In this way, the terminal may update parameters of the structure model according to the first mean square function, the second mean square function and the third mean square function, so as to optimize the structure restoration model. Specifically, the terminal may optimize, based on the first mean square function, a branch where the conv1 in the structure restoration model is located; optimize, based on the second mean square function, branches where the conv1 and the conv2 in the structure restoration model are located; and optimize, based on the third mean square function, branches where the conv1, the conv2 and the conv3 in the structure restoration model are located.

The terminal for executing the image restoration method and the terminal for performing structure model training in the present embodiment may be the same terminal, or may be different terminals. In some possible implementations, the terminal may transmit the trained structure restoration model to a plurality of other terminals, so that the plurality of other terminals can directly use the structure restoration model to implement the image restoration method in the present disclosure.

Based on the description of the above content, the present disclosure provides an image restoration method. A terminal acquires an image to be restored, then inputs the image to be restored into a structure restoration model, obtains a first feature sequence and a second feature sequence by down-sampling the image to be restored based on a plurality of branches of the structure restoration model, converts the first feature sequence into a third feature sequence that has the same length as the second feature sequence, fuses the third feature sequence with the second feature sequence, and performs structure restoration on the image to be restored according to a fused feature sequence, so as to obtain an image in which the structure of the image to be restored is restored. The plurality of branches in the structure restoration model may down-sample the image to be restored in different scales, then extract features of the image to be restored under different scales, and restore the image to be restored according to a fused result, so that a restored image with higher restoration precision and a better effect can be obtained.

In some possible implementations, as shown in FIG. 4, the image restoration method further includes the following steps:

S406: the terminal obtains a second restored image by inputting the first restored image to a texture restoration model.

The second restored image is an image obtained by performing texture restoration on the first restored image. Specifically, the terminal inputs the first restored image into the texture restoration model, down-samples the first restored image by using the model, then flattens the first restored image to obtain a sequence, sends the sequence to an encoder for encoding, then converts the sequence into a two-dimensional feature map, sends the two-dimensional feature map to a deconvolutional layer for deconvolution, and then performs up-sampling to obtain a feature map having the same size as the original image, so as to acquire a final result according to a fully connected (FC) layer, thereby implementing the texture restoration of the first restored image.

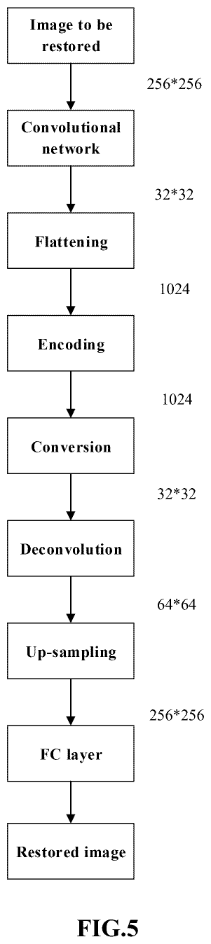

Exemplarily, as shown in FIG. 5, 8-fold down-sampling is performed on the first restored image (the image to be restored) with a size of 256*256 via a convolutional layer to obtain a feature map with a size of 32*32, then the feature map with the size of 32*32 is flattened to obtain a sequence with a length of 1024, the sequence with the length of 1024 is sent to N encoders for encoding, an output result of the encoders is converted into a two-dimensional feature map with a size of 32*32, then deconvolution is performed on the two-dimensional feature map to obtain a feature map with a size of 64*64, the feature map with the size of 64*64 is further up-sampled to obtain a feature map with a size of 256*256, and then a final result is acquired by the FC layer, so that the texture restoration of the first restored image is realized, and the restored image is the second restored image.

The texture restoration model may be trained and obtained by a texture training image. Specifically, the texture training image may be masked, the masked texture training image is down-sampled by the convolutional layer to obtain a feature map of the image, then a sequence obtained by flattening the feature map is sent to an encoder for encoding, a result output by the encoder is converted into a feature map, deconvolution is performed on the feature map, up-sampling is further performed, finally, a texture of the masked texture training image is predicted by the FC layer, and a prediction result is compared with the texture training image to optimize a parameter in the texture restoration model.

S408: the terminal obtains a third restored image by inputting the second restored image to a color restoration model.

The third restored image is an image obtained by performing color restoration on the second restored image. Specifically, the terminal inputs the second restored image into the color restoration model, down-samples the second restored image by using the model, then flattens the second restored image to obtain a sequence, sends the sequence to an encoder for encoding, then converts the sequence into a two-dimensional feature map, sends the two-dimensional feature map to the deconvolutional layer for deconvolution, and then performs up-sampling to obtain a feature map having the same size as the original image, so as to acquire a final result according to the fully connected layer, thereby implementing the texture restoration of the first restored image.

Exemplarily, as shown in FIG. 5, 8-fold down-sampling is performed on the second restored image (the image to be restored) with a size of 256*256 via the convolutional layer to obtain a feature map with a size of 32*32, then the feature map with the size of 32*32 is flattened to obtain a sequence with a length of 1024, the sequence with the length of 1024 is sent to N encoders for encoding, an output result of the encoders is converted into a two-dimensional feature map with a size of 32*32, then deconvolution is performed on the two-dimensional feature map to obtain a feature map with a size of 64*64, the feature map with the size of 64*64 is further up-sampled to obtain a feature map with a size of 256*256, and then a final result is acquired by the FC layer, so that the color restoration of the second restored image is realized, and the restored image is the third restored image.

The color restoration model may be trained and obtained by a color training image. Specifically, the color training image may be masked, the masked color training image is down-sampled by the convolutional layer to obtain a feature map of the image, then a sequence obtained by flattening the feature map is sent to an encoder for encoding, a result output by the encoder is converted into a feature map, deconvolution is performed on the feature map, up-sampling is further performed, finally, a color of the masked color training image is predicted by the FC layer, and a prediction result is compared with the color training image to optimize a parameter in the color restoration model.

S406 and S408 are optional steps, the terminal may perform, based on S406, texture restoration on the first restored image that has been subjected to structure restoration; the terminal may also perform, based on S408, color restoration on the first restored image that has been subjected to structure restoration; and the terminal may also perform, based on S406, texture restoration on the first restored image that has been subjected to structure restoration, and perform, based on S408, color restoration on the second restored image that has been subjected to texture restoration. The terminal for executing the image restoration method and the terminal for performing the texture model training and the color model training in the present embodiment may be the same terminal, or may be different terminals. In some possible implementations, the terminal may transmit the trained texture restoration model and/or the trained color restoration model to a plurality of other terminals, so that the plurality of other terminals can directly use the texture restoration model and/or the color restoration model to implement the image restoration method in the present disclosure.

When the method includes the two steps S406 and S408, the image restoration method may gradually implement accurate restoration of the image to be restored from whole to local in three aspects, that is, the structure, the texture and the color of the image to be restored. The structure restoration model, the texture restoration model and the color restoration model are respectively obtained by corresponding training images, so that the three models can respectively learn a structure law, a texture law and a color law of each image, and each model implements accurate restore of a function corresponding to the model, thereby improving the accuracy of model restoration.

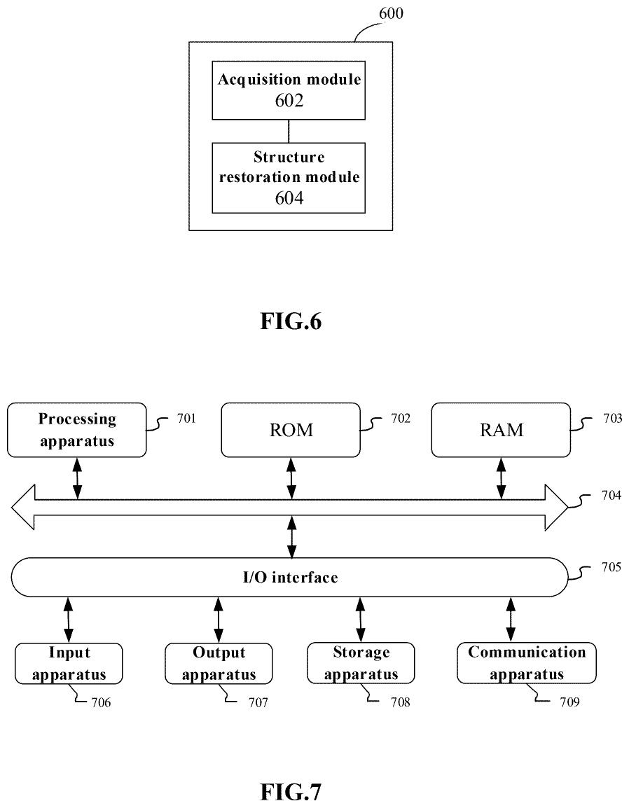

FIG. 6 illustrates a schematic diagram of an image restoration apparatus according to an exemplary embodiment of the present disclosure, and as shown in FIG. 6, the image restoration apparatus 600 includes: an acquisition module 602 and a structure restoration module 604.

The acquisition module 602 is configured to acquire an image to be restored.

The structure restoration module 604 is configured to input the image to be restored into a structure restoration model, obtain a first feature sequence and a second feature sequence by down-sampling the image to be restored based on a plurality of branches of the structure restoration model, convert the first feature sequence into a third feature sequence that has a same length as the second feature sequence, fuse the third feature sequence with the second feature sequence, and obtain a first restored image by performing, according to a fused feature sequence, structure restoration on the image to be restored, wherein the first restored image is an image in which the structure of the image to be restored is restored.

Optionally, the apparatus further includes: a texture restoration module and/or a color restoration module, configured to obtaining a second restored image by inputting the first restored image into a texture restoration model and/or a color restoration model and performing texture restoration and/or color restoration, wherein the second restored image is an image obtained by performing texture restoration and/or color restoration on the first restored image.

Optionally, the structure restoration module 604 is further configured to: obtain a fourth feature sequence by down-sampling the image to be restored based on the plurality of branches of the structure restoration model; and the structure restoration module is specifically configured to: obtain the third feature sequence by up-sampling the fourth feature sequence and fuse the fourth feature sequence with the first feature sequence, the third feature sequence having the same length as the second feature sequence.

Optionally, the apparatus further includes: a texture restoration module, configured to obtain a second restored image by inputting the first restored image into the texture restoration model and performing texture restoration, wherein the second restored image is an image obtained by performing texture restoration on the first restored image; and a color restoration module, configured to obtain a third restored image by inputting the second restored image into the color restoration model and performing color restoration, wherein the third restored image is an image obtained by performing color restoration on the second restored image.

Optionally, the length of the second feature sequence is four times the length of the first feature sequence.

Optionally, the length of the first feature sequence is four times the length of the fourth feature sequence.

Optionally, the structure restoration module 604 is specifically configured to: obtain a fused feature sequence by adding the third feature sequence with the second feature sequence and performing encoding and decoding.

Optionally, the structure restoration model is trained and obtained in the following manner: acquiring a training image, wherein the training image comprises a mask image; obtaining a first training feature sequence and a second training feature sequence by down-sampling the mask image based on the plurality of branches of the structure restoration model, converting the first training feature sequence into a third training feature sequence that has the same length as the second training feature sequence, fusing the third training feature sequence with the second training feature sequence, and obtaining a first training restored image by performing structure restoration on the mask image according to a fused training feature sequence; and updating a parameter of the structure restoration model according to the first training restored image and the training image prior to masking.

Optionally, the structure restoration module 604 is specifically configured to: input the first restored image into the texture restoration model and/or the color restoration model, obtain a fifth feature sequence by down-sampling and encoding the first restored image based on the texture restoration model and/or the color restoration model, obtain a feature map by performing deconvolution on the fifth feature sequence, and obtain the second restored image by performing texture restoration and/or color restoration on the first restored image according to the feature map.

Functions of the foregoing modules are described in detail in the steps of the method in the foregoing embodiment, and thus details are not described herein again.

Hereinafter, referring to FIG. 7, it illustrates a schematic structural diagram of an electronic device 700 suitable for implementing the embodiments of the present application. The terminal device in the embodiments of the present disclosure may include, but is not limited to, mobile terminals such as mobile phones, notebook computers, digital broadcast receivers, PDAs (personal digital assistants), PADs (portable Android devices), PMPs (portable media players), vehicle-mounted terminals (e.g., vehicle-mounted navigation terminals), and the like, and fixed terminals such as digital TVs, desktop computers, and the like. The electronic device shown in FIG. 7 is merely an example, and should not bring any limitation to the functions and use ranges of the embodiments of the present disclosure.

As shown in FIG. 7, the electronic device 700 may include a processing apparatus (e.g., a central processing unit, a graphics processing unit, or the like) 701, which may execute various suitable actions and processes according to a program stored in a read-only memory (ROM) 702 or a program loaded from a storage apparatus 708 into a random access memory (RAM) 703. In the RAM 703, various programs and data needed by the operations of the electronic device 700 are also stored. The processing apparatus 701, the ROM 702 and the RAM 703 are connected with each other via a bus 704. An input/output (I/O) interface 705 is also connected to the bus 704.

In general, the following apparatuses may be connected to the I/O interface 705: an input apparatus 706, including, for example, a touch screen, a touch pad, a keyboard, a mouse, a camera, a microphone, an accelerometer, a gyroscope, and the like; an output apparatus 707, including, for example, a liquid crystal display (LCD), a speaker, a vibrator, and the like; a storage apparatus 708, including, for example, a magnetic tape, a hard disk, and the like; and a communication apparatus 709. The communication apparatus 709 may allow the electronic device 700 to communicate in a wireless or wired manner with other devices to exchange data. Although FIG. 7 illustrates the electronic device 700 having various apparatuses, it should be understood that not all illustrated apparatuses are required to be implemented or provided. More or fewer apparatuses may alternatively be implemented or provided.

In particular, according to the embodiments of the present disclosure, the processes described above with reference to the flowcharts may be implemented as computer software programs. For example, the embodiments of the present disclosure include a computer program product, which includes a computer program carried on a non-transitory computer-readable medium, and the computer program contains program codes for executing the method illustrated in the flowcharts. In such embodiments, the computer program may be downloaded and installed from a network via the communication apparatus 709, or installed from the storage apparatus 708, or installed from the ROM 702. When the computer program is executed by the processing apparatus 701, the above functions defined in the method provided in the embodiments of the present disclosure are executed.

It should be noted that, the computer-readable medium described above in the present disclosure may be either a computer-readable signal medium or a computer-readable storage medium, or any combination of the two. The computer-readable storage medium may be, for example, but is not limited to, an electrical, magnetic, optical, electromagnetic, infrared, or semiconductor system, apparatus or device, or a combination of any of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or a flash memory), an optical fiber, a compact disc read-only memory (CD-ROM), an optical storage device, a magnetic storage device, or any suitable combination of the above. In the present disclosure, the computer-readable storage medium may be any tangible medium that contains or stores a program, wherein the program may be used by or in combination with an instruction execution system, apparatus or device. In the present disclosure, the computer-readable signal medium may include a data signal that is propagated in a baseband or used as part of a carrier, wherein the data signal carries computer-readable program codes. Such propagated data signal may take many forms, including, but not limited to, electromagnetic signals, optical signals, or any suitable combination thereof. The computer-readable signal medium may also be any computer-readable medium other than the computer-readable storage medium, and the computer-readable signal medium may send, propagate or transport the program for use by or in combination with the instruction execution system, apparatus or device. Program codes contained on the computer-readable medium may be transmitted with any suitable medium, including, but not limited to: an electrical wire, an optical cable, RF (radio frequency), and the like, or any suitable combination thereof.

In some implementations, a client and a server may perform communication by using any currently known or future-developed network protocol, such as an HTTP (HyperText Transfer Protocol), and may be interconnected with any form or medium of digital data communication (e.g., a communication network). Examples of the communication network include a local area network (“LAN”), a wide area network (“WAN”), an international network (e.g., the Internet), and a peer-to-peer network (e.g., an ad hoc peer-to-peer network), as well as any currently known or future-developed network.

The computer-readable medium may be contained in the above electronic device; and it may also be present separately and is not assembled into the electronic device.

The computer-readable medium carries one or more programs that, when executed by the electronic device, cause the electronic device to: perform text detection on an image to obtain a text area in the image, wherein the text area includes a plurality of text rows; construct a graph network model according to the text area, wherein each text row in the text area is one node of the graph network model; classify nodes in the graph network model via a node classification model, and classify edges between the nodes in the graph network model via an edge classification model; and obtain at least one key value pair in the image according to a classification result of the nodes and a classification result of the edges. Computer program codes for executing the operations of the present disclosure may be written in one or more programming languages or combinations thereof. The programming languages include, but are not limited to, object-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or the server. In the case involving the remote computer, the remote computer may be connected to the user computer through any type of network, including a local area network (LAN for short) or a wide area network (WAN for short), or it may be connected to an external computer (e.g., through the Internet using an Internet service provider).

The flowcharts and block diagrams in the drawings illustrate system architectures, functions and operations of possible implementations of systems, methods and computer program products according to various embodiments of the present disclosure. In this regard, each block in the flowcharts or block diagrams may represent a part of a module, a program segment or a code, and the part of the module, the program segment or the code contains one or more executable instructions for implementing specified logic functions. It should also be noted that, in some alternative implementations, the functions annotated in the blocks may occur out of the sequence annotated in the drawings. For example, two blocks shown in succession may, in fact, be executed substantially concurrently, or the blocks may sometimes be executed in a reverse sequence, depending upon the functions involved. It should also be noted that each block in the block diagrams and/or flowcharts, and combinations of the blocks in the block diagrams and/or flowcharts may be implemented by dedicated hardware-based systems for executing specified functions or operations, or combinations of dedicated hardware and computer instructions.

The modules involved in the described embodiments of the present disclosure may be implemented in a software or hardware manner. The names of the modules do not constitute limitations of the modules themselves in a certain case.

The functions described herein above may be executed, at least in part, by one or more hardware logic components. For example, without limitation, example types of the hardware logic components that may be used include: a field programmable gate array (FPGA), an application specific integrated circuit (ASIC), an application specific standard product (ASSP), a system on chip (SOC), a complex programmable logic device (CPLD), and so on.

In the context of the present disclosure, a machine-readable medium may be a tangible medium, which may contain or store a program for use by or in combination with the instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium would include an electrical connection based on one or more wires, a portable computer disk, a hard disk, a random access memory (RAM), a read-only memory (ROM), an erasable programmable read-only memory (EPROM or a flash memory), an optical fiber, a compact disc read-only memory (CD-ROM), an optical storage device, a magnetic storage device, or any suitable combination thereof.

According to one or more embodiments of the present disclosure, example 1 provides an image restoration method, including: acquiring an image to be restored; and inputting the image to be restored into a structure restoration model, obtaining a first feature sequence and a second feature sequence by down-sampling the image to be restored based on a plurality of branches of the structure restoration model, converting the first feature sequence into a third feature sequence that has the same length as the second feature sequence, fusing the third feature sequence with the second feature sequence, and obtaining a first restored image by performing structure restoration on the image to be restored according to a fused feature sequence, wherein the first restored image is an image in which the structure of the image to be restored is restored.

According to one or more embodiments of the present disclosure, example 2 provides the method in example 1, the method further includes: obtain a second restored image by inputting the first restored image into a texture restoration model and/or a color restoration model and performing texture restoration and/or color restoration, wherein the second restored image is an image obtained by performing texture restoration and/or color restoration on the first restored image.

According to one or more embodiments of the present disclosure, example 3 provides the method in example 1, the method further includes: obtaining a fourth feature sequence by down-sampling the image to be restored based on the plurality of branches of the structure restoration model; and converting the first feature sequence into the third feature sequence that has the same length as the second feature sequence, includes: obtain the third feature sequence by up-sampling the fourth feature sequence and fusing the fourth feature sequence with the first feature sequence, the third feature sequence having the same length as the second feature sequence.

According to one or more embodiments of the present disclosure, example 4 provides the method in example 1, the method further includes: obtain a second restored image by inputting the first restored image into the texture restoration model and performing texture restoration, wherein the second restored image is an image obtained by performing texture restoration on the first restored image; and obtaining a third restored image by inputting the second restored image into a color restoration model and performing color restoration, wherein the third restored image is an image obtained by performing color restoration on the second restored image.

According to one or more embodiments of the present disclosure, example 5 provides the method in example 1, the length of the second feature sequence is four times the length of the first feature sequence.

According to one or more embodiments of the present disclosure, example 6 provides the method in example 3, the length of the first feature sequence is four times the length of the fourth feature sequence.

According to one or more embodiments of the present disclosure, example 7 provides the method in example 1, fusing the third feature sequence with the second feature sequence includes: obtaining a fused feature sequence by adding the third feature sequence with the second feature sequence and performing encoding and decoding.

According to one or more embodiments of the present disclosure, example 8 provides the method in example 1, the structure restoration model is trained and obtained in the following manner: acquiring a training image, wherein the training image includes a mask image; obtaining a first training feature sequence and a second training feature sequence by down-sampling the mask image based on the plurality of branches of the structure restoration model, converting the first training feature sequence into a third training feature sequence that has the same length as the second training feature sequence, fusing the third training feature sequence with the second training feature sequence, and obtain a first training restored image by performing structure restoration on the mask image according to a fused training feature sequence; and updating a parameter of the structure restoration model according to the first training restored image and the training image prior to masking.

According to one or more embodiments of the present disclosure, example 9 provides the method in example 2, obtaining the second restored image by inputting the first restored image into the texture restoration model and/or the color restoration model and performing texture restoration and/or color restoration includes: inputting the first restored image into the texture restoration model and/or the color restoration model, obtaining a fifth feature sequence by down-sampling and encoding the first restored image based on the texture restoration model and/or the color restoration model, obtaining a feature map by performing deconvolution on the fifth feature sequence, and obtaining the second restored image by performing texture restoration and/or color restoration on the first restored image according to the feature map.

According to one or more embodiments of the present disclosure, example 10 provides an image restoration apparatus, including: an acquisition module, configured to acquire an image to be restored; and a structure restoration module, configured to input the image to be restored into a structure restoration model, obtain a first feature sequence and a second feature sequence by down-sampling the image to be restored based on a plurality of branches of the structure restoration model, convert the first feature sequence into a third feature sequence that has the same length as the second feature sequence, fuse the third feature sequence with the second feature sequence, and obtain a first restored image by performing structure restoration on the image to be restored according to a fused feature sequence, wherein the first restored image is an image in which the structure of the image to be restored is restored.

According to one or more embodiments of the present disclosure, example 11provides the apparatus in example 10, the apparatus further includes: a texture restoration module and/or a color restoration module, configured to obtain a second restored image by inputting the first restored image into a texture restoration model and/or a color restoration model and performing texture restoration and/or color restoration, wherein the second restored image is an image obtained by performing texture restoration and/or color restoration on the first restored image.

According to one or more embodiments of the present disclosure, example 12 provides the apparatus in example 10, the structure restoration module is further configured to: obtain a fourth feature sequence by down-sampling the image to be restored based on the plurality of branches of the structure restoration model; and the structure restoration module is specifically configured to: obtain the third feature sequence by up-sampling the fourth feature sequence and fuse the fourth feature sequence with the first feature sequence, the third feature sequence having the same length as the second feature sequence.

According to one or more embodiments of the present disclosure, example 13 provides the apparatus in example 10, the apparatus further includes: a texture restoration module, configured to obtain a second restored image by inputting the first restored image into the texture restoration model and performing texture restoration, wherein the second restored image is an image obtained by performing texture restoration on the first restored image; and a color restoration module, configured to obtain a third restored image by inputting the second restored image into the color restoration model and performing color restoration, wherein the third restored image is an image obtained by performing color restoration on the second restored image.

According to one or more embodiments of the present disclosure, example 14 provides the apparatus in example 10, the length of the second feature sequence is four times the length of the first feature sequence.

According to one or more embodiments of the present disclosure, example 15 provides the apparatus in example 12, the length of the first feature sequence is four times the length of the fourth feature sequence.

According to one or more embodiments of the present disclosure, example 16 provides the apparatus in example 10, the structure restoration module is specifically configured to: obtain a fused feature sequence by adding the third feature sequence with the second feature sequence and performing encoding and decoding.

According to one or more embodiments of the present disclosure, example 17 provides the apparatus in example 10, the structure restoration model is trained and obtained in the following manner: acquiring a training image, wherein the training image comprises a mask image; obtaining a first training feature sequence and a second training feature sequence by down-sampling the mask image based on the plurality of branches of the structure restoration model, converting the first training feature sequence into a third training feature sequence that has the same length as the second training feature sequence, fusing the third training feature sequence with the second training feature sequence, and obtaining a first training restored image by performing structure restoration on the mask image according to a fused training feature sequence; and updating a parameter of the structure restoration model according to the first training restored image and the training image prior to masking.

According to one or more embodiments of the present disclosure, example 18 provides the apparatus in example 11, the structure restoration module is specifically configured to: input the first restored image into the texture restoration model and/or the color restoration model, obtain a fifth feature sequence by down-sampling and encoding the first restored image based on the texture restoration model and/or the color restoration model, obtain a feature map by performing deconvolution on the fifth feature sequence, and obtain the second restored image by performing texture restoration and/or color restoration on the first restored image according to the feature map.

What have been described above are only preferred embodiments of the present disclosure and illustrations of the technical principles employed. It should be understood by those skilled in the art that, the disclosure scope involved in the preset disclosure is not limited to the technical solutions formed by specific combinations of the above technical features, and meanwhile should also include other technical solutions formed by any combinations of the above technical features or equivalent features thereof without departing from the concept of the disclosure, for example, technical solutions formed by mutual replacement of the above features with technical features having similar functions disclosed in the present disclosure (but is not limited to).

In addition, although various operations are described in a particular order, this should not be understood as requiring that these operations are executed in the particular sequence shown or in a sequential order. In certain environments, multitasking and parallel processing may be advantageous. Similarly, although several specific implementation details have been contained in the above discussion, these should not be construed as limiting the scope of the present disclosure. Some features that are described in the context of separate embodiments may also be implemented in combination in a single embodiment. Conversely, various features that are described in the context of a single embodiment may also be implemented in a plurality of embodiments separately or in any suitable sub-combination.

Although the present theme has been described in language specific to structural features and/or methodological actions, it should be understood that the theme defined in the appended claims is not necessarily limited to the specific features or actions described above. Rather, the specific features and actions described above are merely example forms of implementing the claims. Regarding the apparatus in the above embodiments, the specific manner in which each module executes operations have been described in detail in the embodiments related to the method, and thus details are not repeated herein again.

1. An image restoration method, comprising:
acquiring an image to be restored; and
inputting the image to be restored into a structure restoration model, obtaining a first feature sequence and a second feature sequence by down-sampling the image to be restored based on a plurality of branches of the structure restoration model, converting the first feature sequence into a third feature sequence that has the same length as the second feature sequence, fusing the third feature sequence with the second feature sequence, and obtaining a first restored image by performing, according to a fused feature sequence, structure restoration on the image to be restored, wherein the first restored image is an image in which the structure of the image to be restored is restored.

2. The method according to claim 1, further comprising:
obtaining a second restored image by inputting the first restored image into at least one of a texture restoration model or a color restoration model and performing texture restoration and/or color restoration, wherein the second restored image is an image obtained by performing at least one of texture restoration or color restoration on the first restored image.

3. The method according to claim 1, further comprising:
obtaining a fourth feature sequence by down-sampling the image to be restored based on the plurality of branches of the structure restoration model; and
wherein converting the first feature sequence into the third feature sequence that has the same length as the second feature sequence, comprises:
obtaining the third feature sequence by up-sampling the fourth feature sequence and fusing the fourth feature sequence with the first feature sequence, the third feature sequence having the same length as the second feature sequence.

4. The method according to claim 1, further comprising:
obtaining a second restored image by inputting the first restored image into the texture restoration model and performing texture restoration, wherein the second restored image is an image obtained by performing texture restoration on the first restored image; and
obtaining a third restored image by inputting the second restored image into the color restoration model and performing color restoration, wherein the third restored image is an image obtained by performing color restoration on the second restored image.

5. The method according to claim 1, wherein the length of the second feature sequence is four times the length of the first feature sequence.

6. The method according to claim 3, wherein the length of the first feature sequence is four times the length of the fourth feature sequence.

7. The method according to claim 1, wherein fusing the third feature sequence with the second feature sequence comprises:
obtaining a fused feature sequence by adding the third feature sequence with the second feature sequence and performing encoding and decoding.

8. The method according to claim 1, wherein the structure restoration model is trained and obtained in the following manner:
acquiring a training image, wherein the training image comprises a mask image;
obtaining a first training feature sequence and a second training feature sequence by down-sampling the mask image based on the plurality of branches of the structure restoration model, converting the first training feature sequence into a third training feature sequence that has the same length as the second training feature sequence, fusing the third training feature sequence with the second training feature sequence, and obtaining a first training restored image by performing structure restoration on the mask image according to a fused training feature sequence; and
updating a parameter of the structure restoration model according to the first training restored image and the training image prior to masking.

9. The method according to claim 2, wherein inputting the first restored image into at least one of the texture restoration model or the color restoration model, and obtaining the second restored image by performing texture restoration and/or color restoration, comprises:
inputting the first restored image into at least one of the texture restoration model or the color restoration model, obtaining a fifth feature sequence by down-sampling and encoding the first restored image based on at least one of the texture restoration model or the color restoration model, obtaining a feature map by performing deconvolution on the fifth feature sequence, and obtaining the second restored image by performing texture restoration and/or color restoration on the first restored image according to the feature map.

10. (canceled)

11. A device, comprising a processor and a memory,
wherein the processor is configured to execute an instruction stored in the memory, to cause the device to:
acquire an image to be restored; and
input the image to be restored into a structure restoration model, obtain a first feature sequence and a second feature sequence by down-sampling the image to be restored based on a plurality of branches of the structure restoration model, convert the first feature sequence into a third feature sequence that has the same length as the second feature sequence, fuse the third feature sequence with the second feature sequence, and obtain a first restored image by perform, according to a fused feature sequence, structure restoration on the image to be restored, wherein the first restored image is an image in which the structure of the image to be restored is restored.

12. A non-transitory computer-readable storage medium, comprising an instruction, wherein the instruction instructs a device to:
acquire an image to be restored; and
input the image to be restored into a structure restoration model, obtain a first feature sequence and a second feature sequence by down-sampling the image to be restored based on a plurality of branches of the structure restoration model, convert the first feature sequence into a third feature sequence that has the same length as the second feature sequence, fuse the third feature sequence with the second feature sequence, and obtain a first restored image by perform, according to a fused feature sequence, structure restoration on the image to be restored, wherein the first restored image is an image in which the structure of the image to be restored is restored.

13. (canceled)

14. The device according to claim 11, wherein the device is further caused to:
obtain a second restored image by inputting the first restored image into at least one of a texture restoration model or a color restoration model and performing texture restoration and/or color restoration, wherein the second restored image is an image obtained by performing at least one of texture restoration or color restoration on the first restored image.

15. The device according to claim 11, wherein the device is further caused to:
obtain a fourth feature sequence by down-sampling the image to be restored based on the plurality of branches of the structure restoration model; and
wherein the device is caused to convert the first feature sequence into the third feature sequence that has the same length as the second feature sequence by being caused to:
obtain the third feature sequence by up-sampling the fourth feature sequence and fuse the fourth feature sequence with the first feature sequence, the third feature sequence having the same length as the second feature sequence.

16. The device according to claim 11, wherein the device is further caused to:
Obtain a second restored image by inputting the first restored image into the texture restoration model and performing texture restoration, wherein the second restored image is an image obtained by performing texture restoration on the first restored image; and
obtain a third restored image by inputting the second restored image into the color restoration model and performing color restoration, wherein the third restored image is an image obtained by performing color restoration on the second restored image.

17. The device according to claim 11, wherein the length of the second feature sequence is four times the length of the first feature sequence.

18. The device according to claim 15, wherein the length of the first feature sequence is four times the length of the fourth feature sequence.

19. The device according to claim 11, wherein the device is caused to fusing the third feature sequence with the second feature sequence by being caused to:
obtain a fused feature sequence by adding the third feature sequence with the second feature sequence and performing encoding and decoding.

20. The device according to claim 11, wherein the structure restoration model is trained and obtained in the following manner:
acquiring a training image, wherein the training image comprises a mask image;
obtaining a first training feature sequence and a second training feature sequence by down-sampling the mask image based on the plurality of branches of the structure restoration model, converting the first training feature sequence into a third training feature sequence that has the same length as the second training feature sequence, fusing the third training feature sequence with the second training feature sequence, and obtaining a first training restored image by performing structure restoration on the mask image according to a fused training feature sequence; and
updating a parameter of the structure restoration model according to the first training restored image and the training image prior to masking.

21. The device according to claim 14, wherein the device is caused to input the first restored image into at least one of the texture restoration model or the color restoration model, and obtaining the second restored image by performing texture restoration and/or color restoration by being caused to:
input the first restored image into at least one of the texture restoration model or the color restoration model, obtaining a fifth feature sequence by down-sampling and encoding the first restored image based on at least one of the texture restoration model or the color restoration model, obtaining a feature map by performing deconvolution on the fifth feature sequence, and obtaining the second restored image by performing texture restoration and/or color restoration on the first restored image according to the feature map.

22. The non-transitory computer-readable storage medium according to claim 12, wherein the instruction further instructs a device to:
obtain a second restored image by inputting the first restored image into at least one of a texture restoration model or a color restoration model and performing texture restoration and/or color restoration, wherein the second restored image is an image obtained by performing at least one of texture restoration or color restoration on the first restored image.
